(19) United States
(12) Patent Application Publication
(10) Pub. No.: US 2014/0360738 A1
(43) Pub. Date: Dec. 11, 2014

(54) AUTOMATIC FIRE-PREVENTING AND FIRE-EXTINGUISHING SYSTEM FOR VEHICLES

(71) Applicants: Wen-Kwo Tien, (US); Ming-Yang Tien, Keelung City (TW); Ming-Wei Tien, Keelung City (TW)

(72) Inventor: Wen-Kwo TIEN, Keelung City (TW)

(73) Assignees: Wen-Kwo Tien, Keelung City (TW); Ming-Yang Tien, Keelung City (TW); Ming-Wei Tien, Keelung City (TW)

(21) Appl. No.: 14/246,368

(22) Filed: Apr. 7, 2014

(30) Foreign Application Priority Data
Jun. 5, 2013 (TW) 102119941

(51) Int. Cl. A62C 3/07; A62C 37/10

(52) U.S. Cl. CPC A62C 3/07; A62C 37/10
USPC 169/61

(57) ABSTRACT

An automatic fire-preventing and fire-extinguishing system includes a mercury switch, a fire-extinguishing device, an electromagnetic driving unit and an electromagnetic valve. The fire-extinguishing device includes a fire extinguisher and a hose unit to direct extinguishing agent dispensed by the fire extinguisher to a predetermined flammable section of a vehicle. The electromagnetic driving unit operates the fire extinguisher in a dispensing mode in an activating state of the mercury switch. The electromagnetic valve operates to block fuel flow in a fuel supply line in the activating state of the mercury switch.

### CROSS-REFERENCE TO RELATED APPLICATION

This application claims priority of Taiwanese application no. 102119941, filed on Jun. 5, 2013.

### BACKGROUND OF THE INVENTION

1. Field of the Invention

The present invent ion relates to an automatic fire-preventing and fire-extinguishing system configured for use with a vehicle.

2. Description of the Related Art

In modern day traffic, motor vehicles are a common mode of transportation that is convenient but can sometimes lead to vehicular accidents. Thus, air bags are usually installed in the vehicles. However, in the event of an accident, there is a chance that fire hazard may occur. Usually, a fire extinguisher is placed in the vehicle for putting out any fire. Nevertheless, such measure does not provide for detection of a beginning of a fire hazard in a vehicle. When the fire has spread, it could become uncontrollable by just using the fire extinguisher, resulting in possible human casualties.

### SUMMARY OF THE INVENTION

The object of the present invention is to provide an automatic fire-preventing and fire-extinguishing system configured for increasing safety of a vehicle.

According to the present invention, there is provided an automatic fire-preventing and fire-extinguishing system configured far use with a vehicle, This system includes:
a mercury switch including
   a sealed envelope having a lower portion and an upper portion,
   a first electrical contact disposed at the upper portion of the sealed envelope and disposed to connect electrically to an electric power source,
   a second electrical contact disposed adjacent to the first electrical contact at the upper portion of the sealed envelope, and
   a mercury bead contained in the sealed envelope and movable in the sea led envelope to switch the mercury switch between a deactivating state, where the mercury bead breaks electrical connection between the first electrical contact and the second electrical contact, and an activating state, where the mercury bead makes electrical connection between the first electrical contact and the second electrical contact;
a fire-extinguishing device including a fire extinguisher operable in a dispensing mode to dispense an extinguishing agent, and a hose unit connected to the fire extinguisher and configured to direct the extinguishing agent dispensed by the fire extinguisher to a predetermined flammable section of the vehicle;
an electromagnetic driving unit connected electrically to the second electrical contact, associated removably and operably with the fire extinguisher, and configured to operate the fire extinguisher in the dispensing mode when the electromagnetic driving unit is energized as a result of being connected electrically to the electric power source in the activating state of the mercury switch; and
an electromagnetic valve connected electrically to the second electrical contact, configured to be installed on a fuel supply line of the vehicle, and operable to block fuel flow in the fuel supply line when the electromagnetic valve is energized as a result of being connected electrically to the electric power source in the activating state of the mercury switch.

### BRIEF DESCRIPTION OF THE DRAWINGS

Other features and advantages of the present-invention will become apparent in the following detailed description of the preferred embodiment with reference to the accompanying drawings, of which:

FIG. 1 is a circuit diagram illustrating the preferred embodiment of an automatic fire-preventing and fire-extinguishing system according to the present invention;

FIG. 2 is a schematic diagram illustrating a mercury bead at a lower portion of a sealed envelope of a mercury switch in the preferred embodiment of the present invention;

FIG. 3 is a schematic diagram illustrating the mercury bead at an upper portion of the sealed envelope of the mercury switch in the preferred embodiment of the present invention;

FIG. 4 is a schematic diagram illustrating a fire-extinguishing device in the preferred embodiment of the present invention; and

FIG. 5 is a schematic diagram illustrating the position of an electromagnetic valve in the preferred embodiment of the present invention,

### DETAILED DESCRIPTION OF THE PREFERRED EMBODIMENT

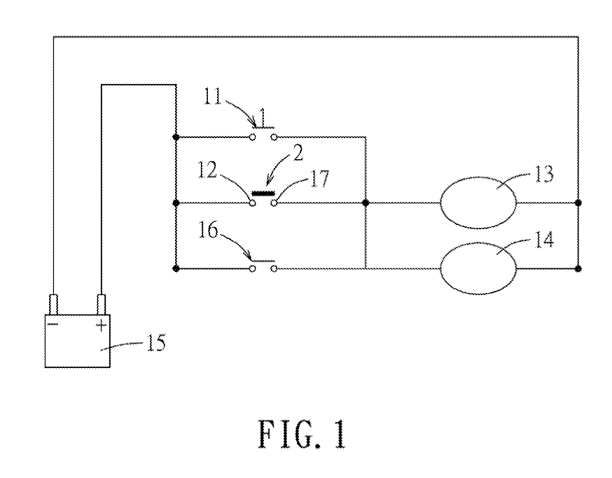

Referring to FIGS. 1, 2 and 4, the preferred embodiment of an automatic fire-preventing and fire-extinguishing system according to this invention is configured for use with a vehicle (not shown) and includes a mercury switch 2 having a first electrical contact 12 coupled electrically with an electric power source 15 (such as a twelve-volt battery) and a second electrical contact 17 disposed adjacent to the first electrical contact 12, a self-holding circuit 16 connected electrically between the first electrical contact 12 and the second electrical contact 17, a manual switch 11 connected electrically between the first electrical contact 12 and the second electrical contact 17 and operable to make or break electrical connection between the first electrical contact 12 and the second electrical contact 17 through the manual switch 11, an electromagnetic driving unit 13 that is connected electrically to the second electrical contact 17, and that is associated removably and operably with a fire extinguisher 31 of a fire-extinguishing device 3, electromagnetic valve 14 that is connected electrically to the second electrical contact 17, and that is configured to be installed on a fuel supply line of the vehicle. The electromagnetic driving unit 13 and the electromagnetic valve 14 are energized by the electric power source 15 and are thus activated when any one of the mercury switch 2, the self-holding circuit IS and the manual switch 11 is in an activating state.

Specifically, the self-holding circuit 16 is electrically coupled with the fire electromagnetic driving unit 13 and the electromagnetic valve 14. When the electromagnetic driving unit 13 (which, in this embodiment, includes an electromagnetic relay) is yet to be energized, the self-holding circuit 16 is in a normally open circuit state, in which electrical connection between the first electrical contact 12 and the second electrical contact 17 through the self-holding circuit 16 is broken. Once the electromagnetic driving unit 13 is energized, the self-holding circuit 16 is switched to and holds a closed circuit stats, in which electrical connection between the first electrical contact 12 and the second electrical contact 1 through the self-holding circuit 16 is made, thereby maintaining the electromagnetic valve 14 and the electromagnetic driving unit 13 in a state of operation in the event that the mercury switch 2 returns from an activating state to a deactivating state, in which electrical connection between the first electrical contact 12 and the second electrical contact 17 via a mercury bead 22 of the mercury switch 2 is broken. Therefore, in the event of a vehicular accident, the electric power source 15 is able to continue to supply electrical power to the electromagnetic valve 14 and the electromagnetic driving unit 13 through the self-holding circuit 16.

In this embodiment, the manual switch 11 may be a manual push button having a transparent glass cover (not shown) to prevent a passenger of the vehicle from unintentionally activating the fire-preventing and fire-extinguishing system. In the event of an accident, the passenger only has to break the glass cover to gain access to the manual push button.

Referring to FIG. 5, the electromagnetic valve 14 is operable to block fuel flow in the fuel supply line. A stop valve 5 is fluidly connected between a fuel tank 4 and the electromagnetic valve 14 and is normally turned on for enabling fuel flow therethrough. The electromagnetic valve 14 is connected electrically to the second electrical contact 17. When the electromagnetic valve 14 is energized as a result of being connected electrically to the electric power source 15 in the activating state of the mercury switch 2, the electromagnetic valve 14 is switched off and operates to block fuel flow in the fuel supply line to an engine of the vehicle, reducing the possibility of fire hazard and explosion due to ignition of the fuel in the event of a vehicular accident. On the other hand, when the electromagnetic valve 14 is not energized, the electromagnetic valve 14 is switched on and operates to allow fuel flow in the fuel supply line.

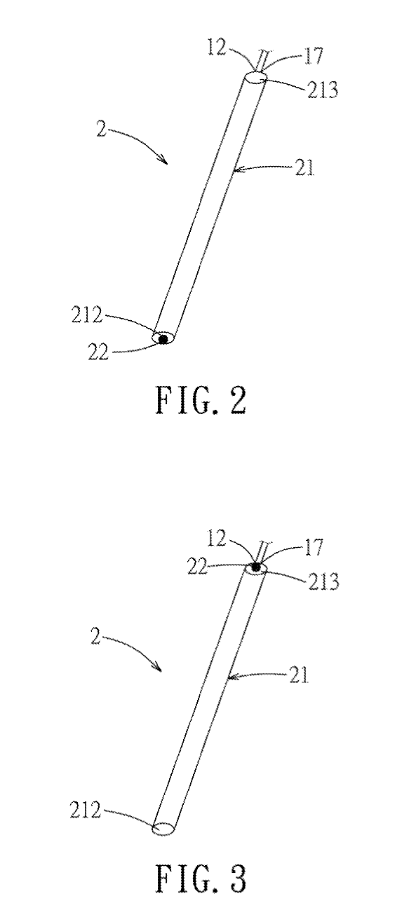

Referring to FIGS. 2 and 3, the mercury switch 2 includes a sealed envelope 21 having a lower portion 212 and an upper portion 213. The first electrical contact 12 and the second electrical contact 17 are disposed adjacent to each other at the upper portion 213 of the sealed envelope 21. The mercury bead 22 is contained in the sealed envelope 21 and is movable in the sealed envelope 21. Preferably, the sealed envelope 21 of the mercury switch 2 forms an angle with the horizon. When the mercury switch 2 is in an activating state, i.e., the mercury switch 2 is subjected to impact of an external force, the mercury bead 22 moves to the upper portion 213 and makes electrical connection between the first electrical contact 12 and the second electrical contact 17, thereby activating the electromagnetic driving unit 13 and the electromagnetic valve 14. The external force may be due to vehicle overturn or heavy impact on the vehicle that can trigger the activation of an airbag system in a vehicle. On the other hand, when the mercury switch 2 is in a deactivating state, i.e., the mercury switch 2 is not subjected to impact of an external force, the mercury bead 22 breaks electrical connection between the first electrical contact 12 and the second electrical contact 17 by remaining at the lower portion 212 due to gravity. In a vehicle that has an airbag system installed, the airbag system is activated at the same time the mercury switch 2 is switched to the activating state.

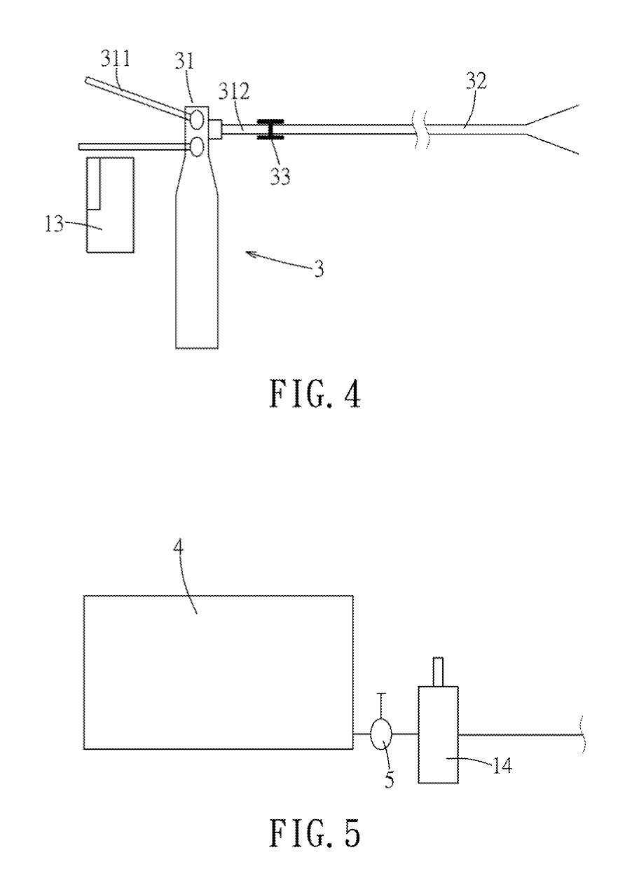

FIG. 4 shows the fire-extinguishing device 3 including the fire extinguisher 31 configured to be operated by the electromagnetic driving unit 13 in a dispensing mode for dispensing an extinguishing agent, a hose unit 32 connected to the fire extinguisher 31 and configured to direct the extinguishing agent dispensed by the fire extinguisher 31 to a predetermined flammable section of the vehicle, and a connector 33 for connecting removably the fire extinguisher 31 to the hose unit 32. The predetermined flammable section of the vehicle may be a section in a vicinity of a fuel system of the vehicle or a section in a vicinity of an exhaust pipe system of the vehicle. The fire extinguisher 31 includes a control lever 311 that is driven by the electromagnetic driving unit 13 (such as but not limited to magnetic attraction) to operate the fire extinguisher 31 in the dispensing mode, and a spout 312 through which the extinguishing agent is dispensed. Specifically, the extinguishing agent is a dry chemical (such as product code HFC-236FS) or dry power. The connector 33 enables the spout 312 of the fire extinguisher 31 to be speedily removed from the hose unit 32. Therefore, when a fire hazard occurs in or out of the vehicle, the fire extinguisher 31 can be removed from the electromagnetic driving unit 13 and the connector 33 quickly for extinguishing the fire. Thus, having the fire extinguisher 31 as a standard equipment of the vehicle greatly increases safety. A suitable type and capacity of the fire extinguisher 31 can be selected depending on the vehicle type.

In summary, the automatic fire-preventing and fire-extinguishing system of the present invention can be manually switched on with the manual switch 11, and be automatically switched on by the mercury switch 2 to activate the electromagnetic valve 14 for blocking fuel flow in the fuel supply line and to activate the fire-extinguishing device 3 for extinguishing fire as soon as if occurs.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An automatic fire-preventing and fire-extinguishing system configured for use with a vehicle, comprising:
a mercury switch including
a sealed envelope having a lower portion and an upper portion,
a first electrical contact disposed at said upper portion of said sealed envelope and disposed to connect electrically to an electric power source,
a second electrical contact disposed adjacent to said first electrical contact at said upper portion of said sealed envelope, and
a mercury bead contained in said sealed envelope and movable in said sealed envelope to switch said mercury switch between a deactivating state, where said mercury bead breaks electrical connection between said first electrical contact and said second electrical contact, and an activating state, where said mercury bead makes electrical connection between said first electrical contact and said second electrical contact;
a fire-extinguishing device including a fire extinguisher operable in a dispensing mode to dispense an extinguishing agent, and a hose unit connected to said fire extinguisher and configured to direct the extinguishing agent dispensed by said fire extinguisher to a predetermined flammable section of the vehicle;
an electromagnetic driving unit connected electrically to said second electrical contact, associated removably and operably with said fire extinguisher, and configured to operate said fire extinguisher in the dispensing mode when said electromagnetic driving unit is energized as a result of being connected electrically to the electric power source in the activating state of said mercury switch; and
an electromagnetic valve connected electrically to said second electrical contact, configured to be installed on a fuel supply line of the vehicle, and operable to block fuel flow in the fuel supply line when said electromagnetic valve is energized as a result of being connected electrically to the electric power source in the activating state of said mercury switch.

2. The automatic fire-preventing and fire-extinguishing system according to claim 1, further comprising a self-holding circuit connected electrically between said first electrical contact and said second electrical contact and associated, operably with said electromagnetic driving unit,
said self-holding circuit being in a normally open circuit state, in which, electrical connection between said first electrical contact and said second electrical contact through said self-holding circuit is broken, when said electromagnetic driving unit is yet to be energized;
said self-holding circuit being switched to and holding a closed circuit state, in which electrical connection between said first electrical contact and said second electrical contact through said self-holding circuit is made, once said electromagnetic driving unit is energized.

3. The automatic fire-preventing and fire-extinguishing system according to claim 1, further comprising a manual switch connected electrically between said first electrical contact and said second electrical contact and operable to make or break electrical connection between said first electrical contact and said second electrical contact through said manual switch.

4. The automatic fire-preventing and fire-extinguishing system, according to claim 1, wherein said fire extinguisher includes a control lever that is driven by said electromagnetic driving unit to operate said fire extinguisher in the dispensing mode, and a spout through which the extinguishing agent is dispensed;
said fire-extinguishing device further including a connector for connecting removably said spout to said hose unit.

5. The automatic fire-preventing and fire-extinguishing system according to claim 1, wherein said electromagnetic valve is operable to permit fuel flow in the fuel supply line when said electromagnetic valve is in a non-energized state, and to block fuel flow in the fuel supply line when said electromagnetic valve is in an energized state.

6. The automatic fire-preventing and fire-extinguishing system according to claim 1, wherein the predetermined flammable section of the vehicle is one of a section in a vicinity of a fuel system of the vehicle and a section in a vicinity of an exhaust pipe system of the vehicle.

7. The automatic fire-preventing and fire-extinguishing system according to claim 1, wherein the extinguishing agent is a dry chemical or dry power.
